(19) United States
(12) Patent Application Publication
(10) Pub. No.: US 2005/0235707 A1
(43) Pub. Date: Oct. 27, 2005

(54) Hooking tool structure

(75) Inventor: Renny Tse-Haw Ling, Jhonghe City (TW)

Correspondence Address: LADAS & PARRY, 26 WEST 61ST STREET, NEW YORK, NY, 10023, US

(73) Assignee: SINOX COMPANY LTD.

(21) Appl. No.: 11/110,254

(22) Filed: Apr. 20, 2005

(30) Foreign Application Priority Data
Apr. 21, 2004 (TW) 093206136

(51) Int. Cl. E05B 37/02

(52) U.S. Cl. 70/29

(57) ABSTRACT

A hooking tool structure comprises a main body interconnected with a shackle, a press member pivotally connected to the main body, and an elastic biasing member; said shackle mainly formed by a fastener buckling with a movable member, so as to form an enclosed space together with the main body; wherein when the movable member is directly subject to a force, or interacts with the press member as the force is applied to the press member, one end of the movable member is disengaged from one end of the fastener and is pushed to a position where a hooking notch is formed; wherein the press member and the movable member are arranged in an unilateral pushing interaction, i.e. as the press member is pushed down by a force, it may push the movable member at the same time; however, when the movable member is pushed directly by a force, the press member will remain unmoved or stationary, and thus is laborsaving.

### FIELD OF THE INVENTION

The present invention relates to a hooking tool structure, a hooking tool attached with a shackle; and in particular to a shackle of a two-piece construction, and disposed with an interacting switch so as to drive the shackle to act.

### DESCRIPTION OF THE PRIOR ART

FIG. 1 shows a hooking tool A interconnected with a shackle A1. The shackle consists of a fixed portion A11 and a movable portion A12, and the movable portion may be pushed by an external force to form a hooking notch, so that the hooking tool may be used for hooking articles through said notch.

For such hooking tools, many related products at present have an interacting switch A2 further mounted on the hooking tools, so that any required movement of the movable member may be achieved by driving the interacting switch.

For example, a hooking tool combined with a lock mechanism is disclosed in U.S. Pat. No. 6,381,997, Chen etc. The hooking tool is provided with a rotary block 60 and an unlock key 50 in an interactive relationship. When an external force is applied to the press face 52 of the unlock key 50, the rotary block 60 is driven thereby to rotate synchronously, so that the lock portion 61 of the rotary block 60 forms a hooking notch with respect to the shackle 35.

It can be understood that the rotary block 60 and the unlock key 50 is provided with an interaction relationship, for the purpose that the rotary block 60 may change its position through the interaction with the unlock key 50. But in different states of use, it is possible for its user to successfully hook onto the hooked object by forming a hooking notch as the lock portion 61 can be directly pressed onto the hooked object. However, limited by the interaction relationship, even if the rotate block 60 is driven directly by a force, the unlock key 50 may also be interacted synchronously with the rotary block 60 which is moved by the force. In other words, in order to push the lock portion 61 forward, only if the applied force is sufficient to move the rotate block 60 and the unlock key 50 together, the displacement of the lock portion 61 may be achieved.

### SUMMARY OF THE INVENTION

The main objective of the present invention is to provide a hooking tool structure, comprising a main body interconnected with a shackle, a press member pivotally connected to the main body and an elastic biasing member. The said shackle comprises a fastener buckling with a movable member, so as to form an enclosed space altogether with the main body; when the movable member is directly subject to a force, or interacts with the press member as the force is applied to the press member, one end of the movable member is disengaged from one end of the fastener and is pushed to a position where a hooking notch is formed. The present invention is characterized in that the press member and the movable member are arranged in an unilateral pushing interaction, i.e. as the press member is pushed down by a force, it will push the movable member as a result; however, when the movable member is subject to a pushing force directly, the press member will remain unmoved or stationary. Comparing to the interacting switch disclosed in the U.S. '997 Patent, the movable member of the present invention is laborsaving as driven directly by a force.

### BRIEF DESCRIPTION OF THE DRAWINGS

FIG. 1 is a schematic view of a conventional hooking tool structure;

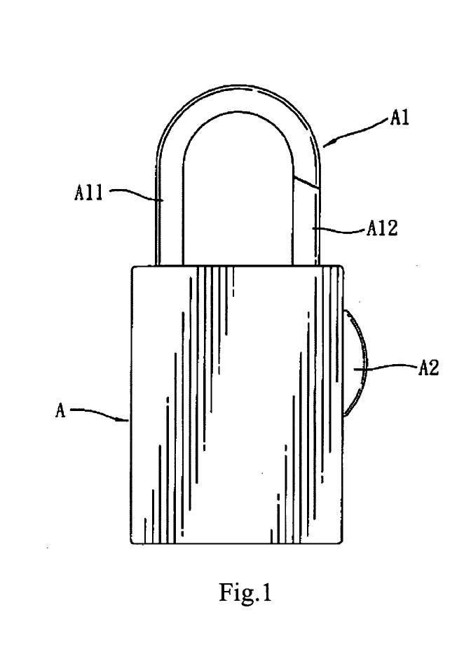

FIG. 2 is a plan schematic view of a hooking tool structure of the present invention;

FIGS. 3A, 3B are two schematic views of a hooking tool structure of the present invention in two different modes of operation; and

FIG. 4 is a schematic view of a structure of a hooking tool of the present invention combined with a lock mechanism.

### DETAILED DESCRIPTION

With reference to the drawings, the technical contents and the elements disclosed in the present invention are illustrated as follows:

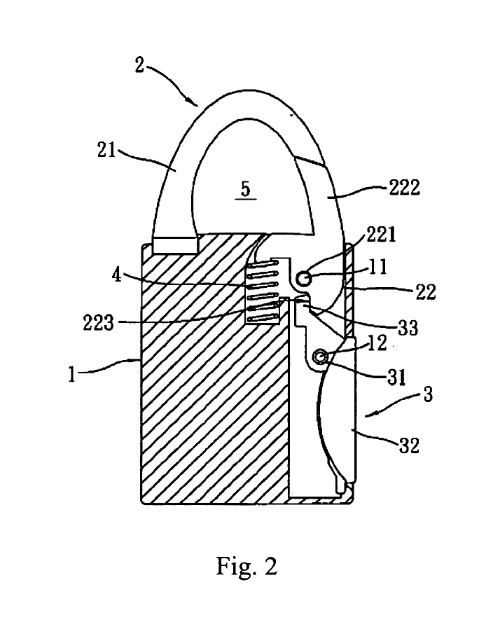

FIG. 2 is a combined cutaway view showing the preferred embodiment of the present invention. As shown in FIG. 2, the present invention comprises a main body 1, a shackle 2, a press member 3, and an elastic biasing member 4, wherein said shackle 2 comprises a fastener 21 having two ends, in which one end is secured to the main body 1 and a movable member 22 having two ends, in which one end is pivotally connected to the main body 1, wherein the other end of the fastener in association with the other end of the movable member form an enclosed space 5 together with the main body 1, as a ring that may be associated with the object to be hooked.

Two axles 11, 12 are disposed on the main body 1 for the movable member 22 and the press member 3 to be telescoped into their positioning holes 221, 31 respectively, so that the movable member 22 and the press member 2 may rotate about the axles 11, 12 with respect to the main body 1.

The movable member 22 is provided with an extension rod 222. The said extension rod 222 may be moved to a position through rotation, where it could be disengaged from one end of the fastener 21, where a hooking notch 51 is formed. As an elastic force is applied to the movable member 22 by the elastic biasing member 4, the extension rod 222 shall be kept in position while maintaining the enclosed space 5 as no force is applied to the moveable part 22.

In addition, the moveable part 22 is provided with a thrust face 223, which acts as a stress face for accepting the force from the press member 3; and the press member 3 is provided with a stress portion 32 apart from the shackle 2, and an actuation portion 33 against the thrust face 223. Thereby, while the stress portion 32 is moved by an external force and thus drives the actuation portion 33 to rotate, the thrust face 223 may also be moved by the actuation portion 33, and thus pushing the movable member 22 synchronously.

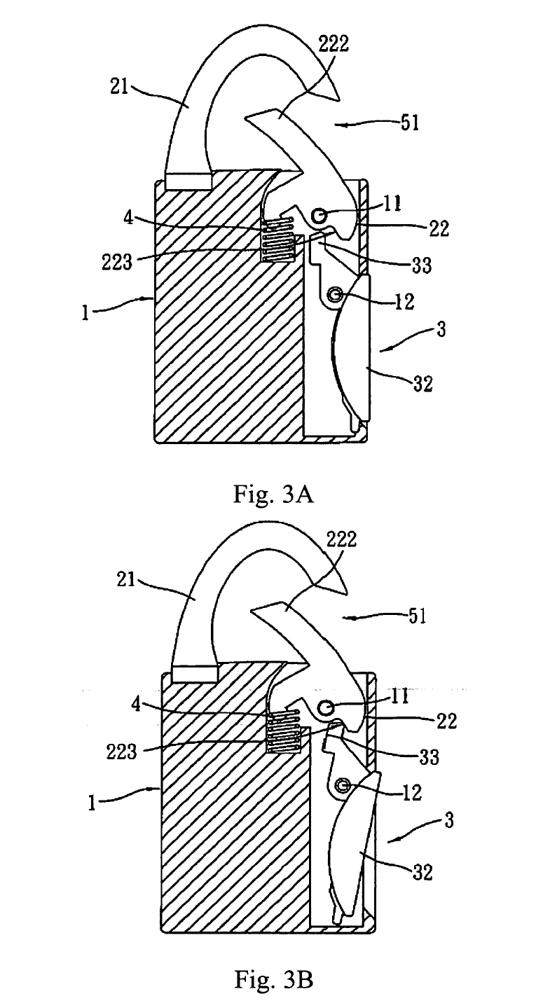

As shown in FIG. 3A, when the stress portion 32 is pressed by an external force and the press member 3 is thereby rotated, and the movable member 22 is also rotated due to the force produced by the actuation portion 33 to the thrust face 223, the extension rod 222 may be disengaged from one end of the fastener and moved to a position where the hooking notch 51 is formed.

FIG. 3B shows the state of forming a hooking notch 51 where the extension rod 222 is directly pushed by an external force. As shown in FIG. 3B, the press member 3 shall be kept at its original position, rather than being driven synchronously by the movable member 22.

In view of the above, the interacting switch of the present invention, consisting of the movable member 22 and the press member 3, is of a single-interaction mode. In brief, the press member 3 may drive the movable member 22 to move together, but if the movable member 22 itself is moved by a direct force, the press member 3 shall remain unmoved or stationary.

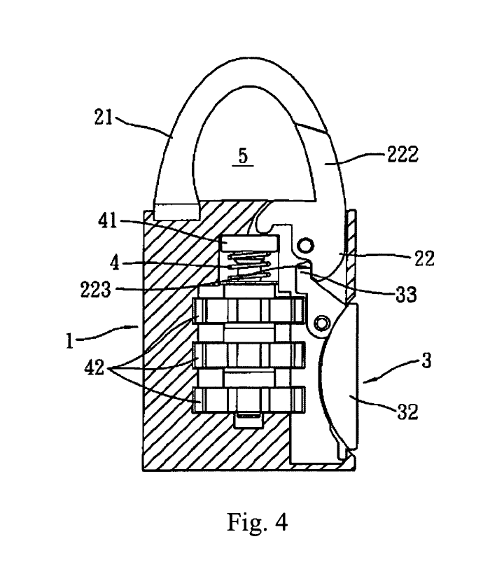

In reference to FIG. 4, besides directly acting on the movable member 22, the elastic biasing member 4 may, in operation, indirectly apply an elastic force to the movable member 22 through a shaft 41 which may axially rotate in the main body 1; moreover, it is possible to provide a plurality of dial wheels 42 to be telescoped onto the shaft 41, so that the elastic biasing member 4, the shaft 41 and the plurality of dial wheels 42 together form a lock mechanism; a movement limitation shall be imposed to or released from the shaft 41 by setting a rotation location of the corresponding rotor 42 with respect to the shaft 41, thus the shaft 41 may become a free part, to realize displacements from the pushing of the moveable part 22.

The above mentioned are only the preferred embodiments of the present invention, and not intended to limit the scope of the invention. Thus the equivalent varieties and modifications and the like according to the claims of the present invention shall be within the scope contemplated by this invention.

1. A hooking tool structure, comprising
a main body;
a shackle pivotally connected to the main body so as to form an enclosed space, said shackle comprising a fastener having two ends, in which one end is secured to the main body and a movable member having two ends in which one end is pivotally connected with said main body, wherein the other end of the fastener in association with the other end of the movable member form the enclosed space, the movable member can be disengaged from one end of the fastener and move to a position where a hooking notch is formed, and the outer edge of the movable member is provided with a thrust face;
an elastic biasing member for applying an elastic force to said movable member so as to keep the movable member at a position maintaining the enclosed space; and
a press member pivotally connected to the main body, said press member is provided with a stress portion apart from the shackle, and an actuation portion against the thrust face; when the stress portion is moved by an external force and thus driving the actuation portion to rotate, the thrust face is moved by the actuation portion, and thus the movable member is pushed to a position where the hooking notch is formed.

2. The hooking tool structure according to claim 1, wherein the elastic biasing member indirectly applies an elastic force to the shackle through a shaft, and the shaft rotate axially within the main body.

3. The hooking tool structure according to claim 2, wherein a plurality of dial wheels are telescoped onto the shaft, and said dial wheels may be rotated to impose movement limitations to the shaft.
